(19) United States
(12) Patent Application Publication
(10) Pub. No.: US 2004/0158538 A1
(43) Pub. Date: Aug. 12, 2004

(54) Method for creating mass shipping orders

(76) Inventors: Marc Alan Sherman, Fort Worth, TX (US); Christopher Michael Warnken, Azle, TX (US)

Correspondence Address: CARSTENS YEE & CAHOON, LLP, P O BOX 802334, DALLAS, TX, 75380

(21) Appl. No.: 10/365,259

(22) Filed: Feb. 12, 2003

(51) Int. Cl. G06F 17/60

(52) U.S. Cl. 705/400

(57) ABSTRACT

A method, program, and system for creating mass shipping orders is provided. The invention includes receiving an order to be sent to a plurality of specified locations, wherein all of the locations are to receive the same order contents. A shipping address for each of the plurality of specified locations is retrieved from a database. A shipping order template is created, wherein the shipping order template specifies the contents of the order and has a blank field for designating a delivery address to which the order should be sent. A separate shipping order is then created for each of the plurality of shipping addresses, wherein a copy of the shipping order template is created and a delivery addresses is filled into the blank field, wherein the separate shipping orders for the plurality of delivery addresses all have the same contents.

### BACKGROUND OF THE INVENTION

1. Technical Field

The present invention relates generally to automated order fulfillment, and more specifically to automated creation of multiple shipping orders.

2. Description of Related Art

Modem mass distribution systems often employ “push” orders. In contrast to fulfilling specific product orders from distributors, push orders comprise sending pre-specified numbers of particular items to distributors at regular intervals, without waiting for orders. Therefore, push orders are proactive, rather than reactive. For example, a company that sells mobile telephones might specify a push order that consists of five phone models, with a specified number of each model. In addition, the push order might also include particular accessories for the phones, as well as customer literature (e.g., promotional brochures). The items included in this push order would then be sent to specific distributors at regular intervals. For example, the push order described above might be sent every month to retail stores operating is shopping centers of a certain size or in a particular geographic region.

Distributors include direct (brand) retailers, indirect retailers (e.g., department stores), kiosks, etc. Product manufacturers and suppliers can further classify distributors according to geographic region, population density, language markets (e.g., Spanish), and any other classification that might be relevant for business purposes. The suppliers can choose a defined group of distributors (e.g., all kiosks in the New England market) and send the same push order to each of the distributors in the group.

Currently, when a push order is sent to a specified group of distributors, the shipping orders for each separate location must be created one at a time, even though all of the locations in the group are receiving identical items and quantities. Therefore, it would be desirable to have a method for automatically creating orders for multiple locations based on a single push order content.

### SUMMARY OF THE INVENTION

The present invention provides a method, program, and system for creating mass shipping orders. The invention includes receiving an order to be sent to a plurality of specified locations, wherein all of the locations are to receive the same order contents. A shipping address for each of the plurality of specified locations is retrieved from a database. A shipping order template is created, wherein the shipping order template specifies the contents of the order and has a blank field for designating a delivery address to which the order should be sent. A separate shipping order is then created for each of the plurality of shipping addresses, wherein a copy of the shipping order template is created and a delivery addresses is filled into the blank field, wherein the separate shipping orders for the plurality of delivery addresses all have the same contents.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4 depicts a flowchart illustrating an automated mass order creation process in accordance with the present invention;

FIG. 5 depicts a flowchart illustrating a standard mass shipment process in accordance with the prior art; and

FIG. 6 depicts a flowchart illustrating an automated mass order shipping process in accordance with the present invention.

### DETAILED DESCRIPTION OF THE INVENTION

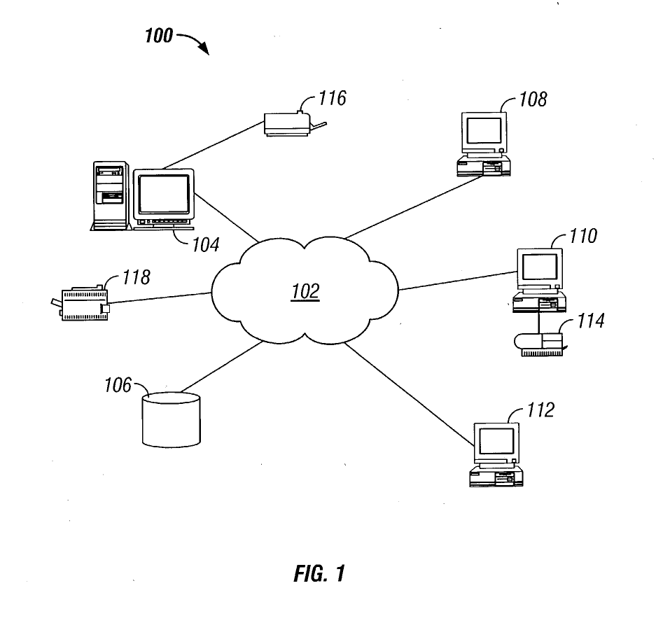

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 includes printers 114, 116, and 118, and may also include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

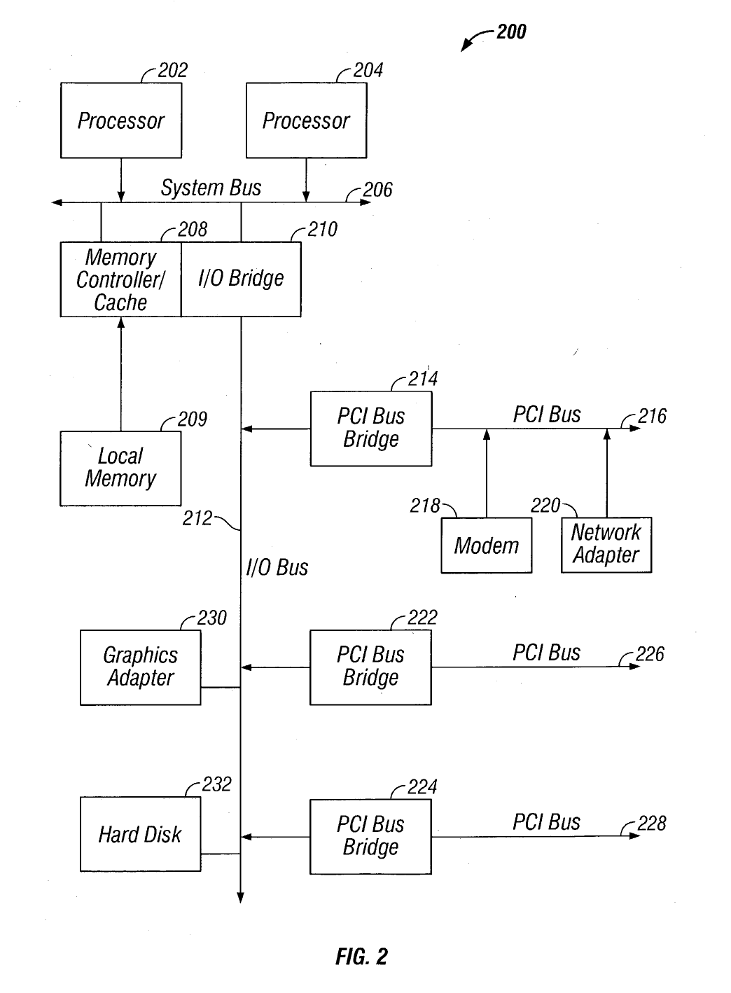

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an eServer pSeries system, a product of International Business Machines Corporation in Armonk, N.Y., running the Advanced Interactive Executive (AIX) or Linux operating systems.

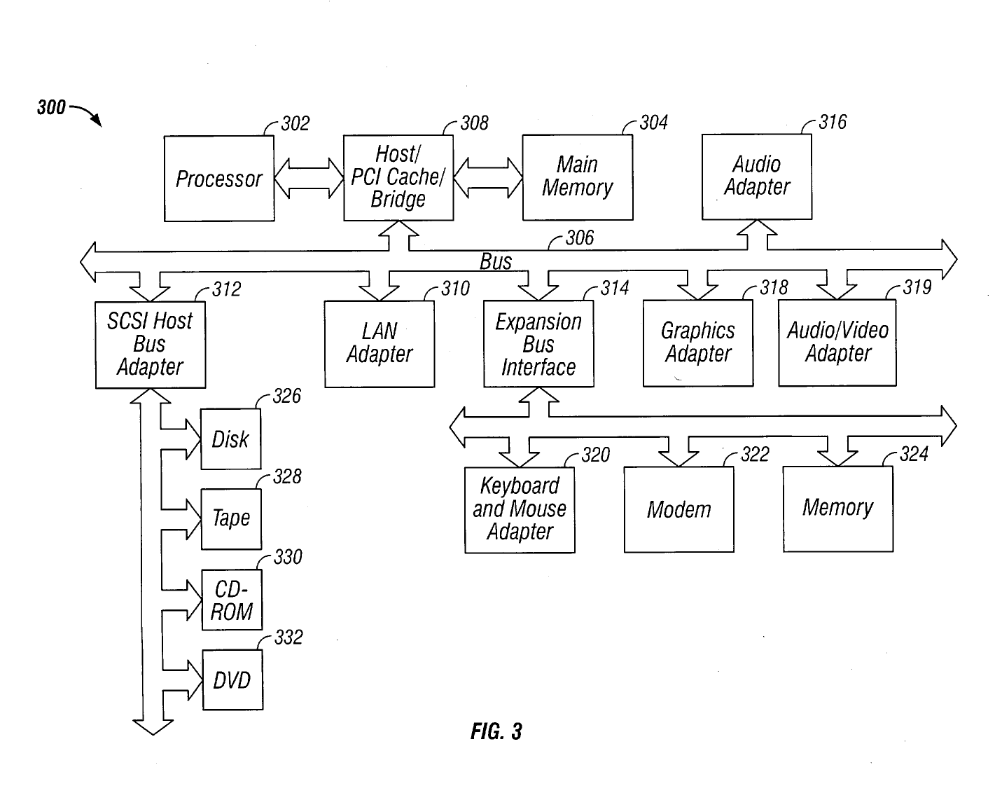

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

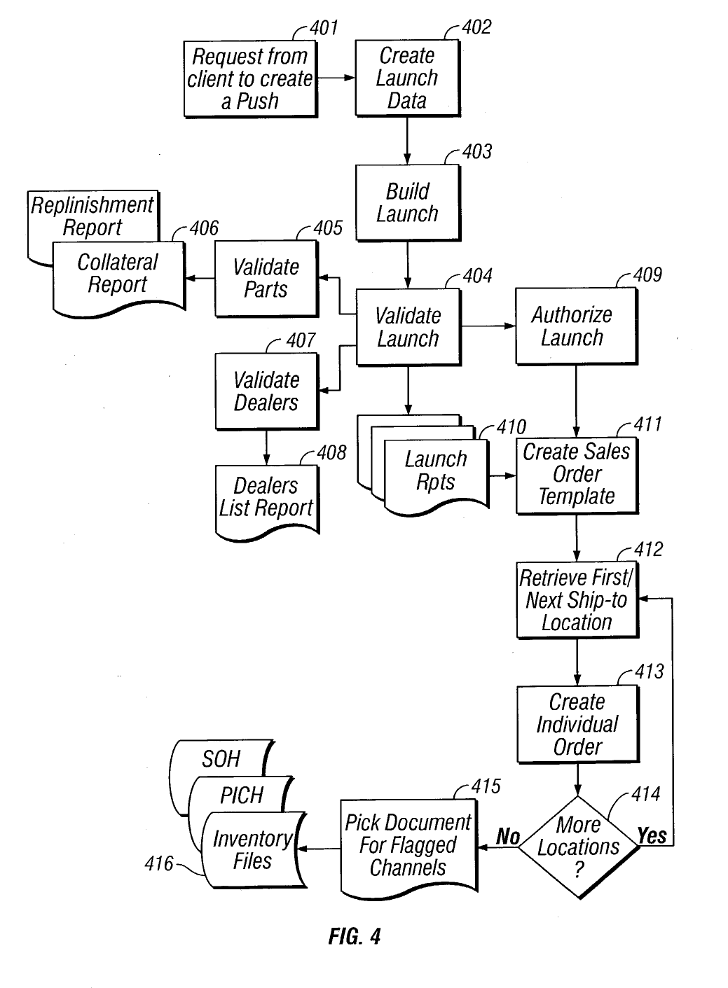

Referring now to FIG. 4, a flowchart illustrating an automated mass order creation process is depicted in accordance with the present invention. The client submits a request to create a mass push order (step 401). In the request, the client provides a set of criteria for the push order, which include not only the contents of the order but the types of distributors to which the order is to be sent. The contents of the push order might include the items to be included and the quantity of each item, as well as shipment method. In addition, the criteria include a defined market, which might be designated in terms of geography, demographics, distributor type (e.g., direct (brand) retail, indirect retailers) or a combination of these factors.

In response to the request, the system creates the launch data based on the criteria provided by the client (step 402) and builds the launch (step 403). This involves coalescing the information that make up the push order criteria and retrieving all distributor locations that match the market criteria included in the push order request. These locations are retrieved from a database that is updated by the client and contains all approved distributors. This information is used to create an order template that provides a common order form that can be used with all of the locations that match the push order criteria. The particular items and respective quantities of those items will be the same for all of the locations receiving the push order. The main variable in the order template is the specific shipping address.

The order template might also designate a sales channel, which specifies the type of distributor receiving the push order. Types of sales channels include direct brand retailer, indirect retailers such as department stores, kiosks, small “mom and pop” stores, and individual sales persons. The push order in question might include one or a combination of these sales channels, depending on the criteria in the client request.

The system validates the launch (step 404). This is done in two parts. One part of the validation process is to validate the parts included in the content of the order (step 405). This may result in the production of replenishment and collateral reports 406. A replenishment report indicates that the inventory of the distributors in question has been replenished. Collateral refers to supplementary product literature that may be sent to distributors.

The other part of the validation process is to validate the dealers included in the push (step 407). This results in the production of a dealer list report 408. This report shows all “Ship To” locations based on the selection criteria. This is used in conjunction with an operations revision control process to validate that sufficient inventory of the correct version is available to create the mass push order. Once validation is complete, the push order is created. There are both detailed and summary reports.

After the validation process, the launch is authorized (step 409) and launch reports 410 are created. These reports break out all the “Ship To” locations for which the push order was and gives order-level detail according to sales channel (e.g., business to business, wholesale, etc.). This tells operations which quantities were sent to which locations.

The system then creates all of the individual orders in the mass push order. This process comprises three steps for automatically creating separate orders for each of the locations that meet the push order criteria. The first step is to create the order template (described above) that provides the common order content for all of the shipping locations (step 411). As described above, the same order template is used for all of the locations in question, but the shipping address and order number is different for each separate location. In this way, the same order content might be sent to, e.g., 10,000 separate locations, by using a single template without the need to create each of the 10,000 orders from scratch one at a time.

After the template is created, the system retrieves the first ship-to location (step 412). As described above, the ship-to locations are gathered from a database according to the push order criteria. The system then creates an individual order is by placing the ship-to address into the appropriate field in the order template (step 413). The system then determines if there are more ship-to addresses remaining in the mass push order (step 414). If there are more locations, the system retrieves the next one (step 412) and continues creating individual orders for all of the locations in the mass order.

After the mass creation of the individual sales orders has been completed, pick documents 415 are created for orders in flagged channels (e.g., Business to Business and wholesalers). Pick documents are used by the warehouse personnel to load the boxes for shipping locations that are listed under the flagged channels. Other channels do not require pick documents. For these, the pick document is created in the background and never printed. The information in pick documents 415 may also stored in particular files 416, e.g., Sales Order Header (SOH), Pick Header (PICH), and inventory files. These are database files where part of the sales order information stored.

A clear distinction must be understood between the creation of an order and the shipment of that order; these are unique and separate processes both physically and systematically. The creation of the order is the process by which a requirement for a specific type and quantity of inventory is committed in the order management and inventory system. This inventory commitment is then calculated against all other orders being placed to ensure inventory is available to promise to other customers placing orders. No inventory is decremented until the order is shipped; only the reservation of inventory and the demand is recorded. Once an order is created it may be fulfilled at any time or cancelled. No further is action is taken until the decision is made to release the order for shipment. At that time the physical process of picking the inventory is accomplished. Once complete, the order is placed in a shipping container and systematically processed to relieve the inventory and remove the commitment. At the same time the shipment is manifested to a carrier for transportation to the requested ship to address. The order is then invoiced and recorded for history purposes.

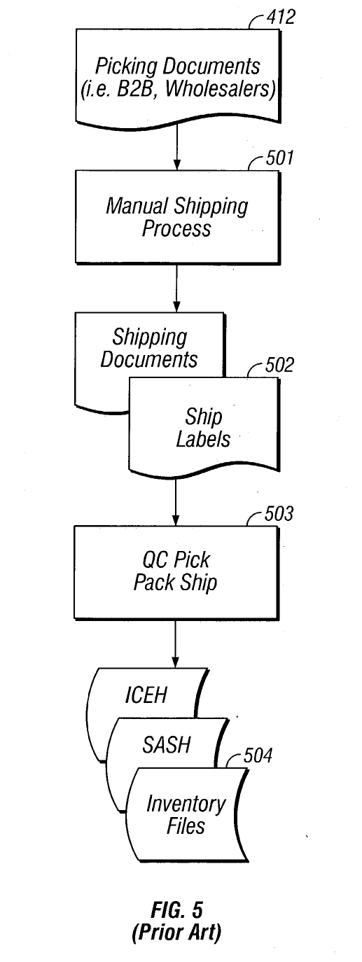

Referring now to FIG. 5, a flowchart illustrating a standard mass shipment process is depicted in accordance with the prior art. The process begins with the shipping personnel receiving some type of order document, e.g., the picking document 412 from the mass order process described above. The personnel use this order document to perform a manual shipping process (step 501) in which each separate shipping order is created one at a time based on the order document. This includes manually creating shipping documents and labels 502 for each separate shipment. Once the shipping orders are created, warehouse personnel can pick out the ordered items and pack each shipment (step 503). After each shipment is prepared and ready to go, updates are made to various data files 504 to reflect the shipment. Such files include inventory, Invoice Header (ICEH), and Sales Order Analysis Header (SASH).

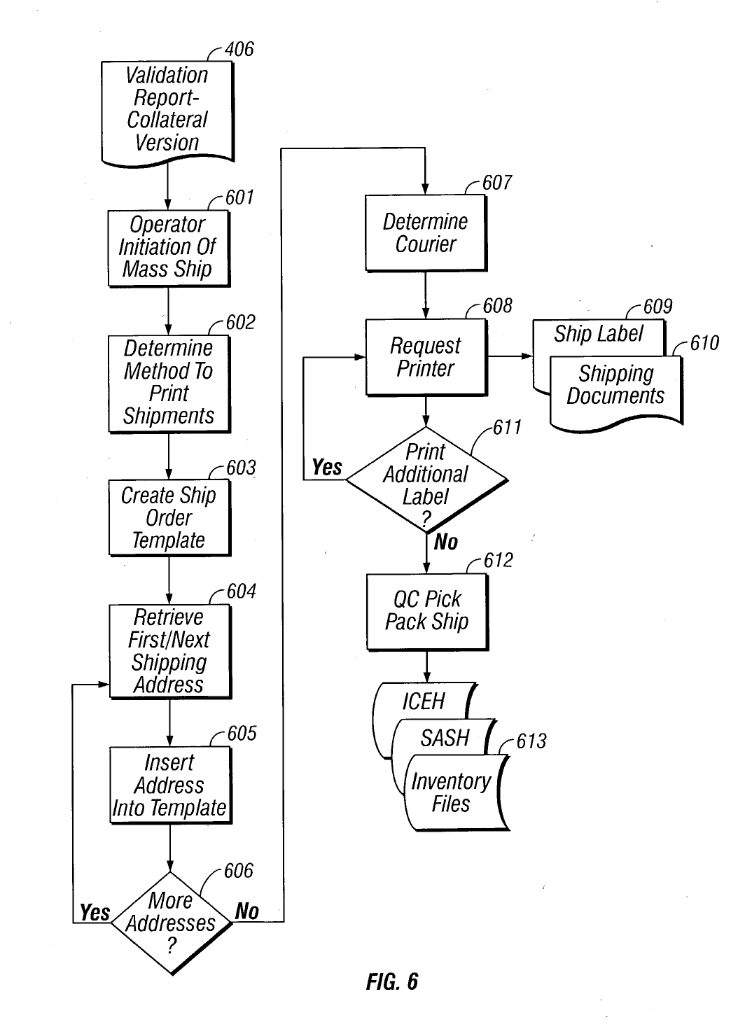

Referring to FIG. 6, a flowchart illustrating an automated mass order shipping process is depicted in accordance with the present invention. Unlike the prior art method, the present invention does not require each shipping order to be manually created one at a time. Rather than relying on separate picking documents for each order, the present invention only needs a single validation report 406 for the mass push order. Once the validation report 406 is received, an operator initiates the mass ship process (step 601).

The systems determine which method to print the shipments (step 602). This method will be based on the shipping carrier as well as other criteria received from the client. Once the printing method is determined, the system mass creates the separate shipping orders for all of the locations in the push order.

The system creates a common ship order template for producing the separate shipping orders (step 603). This template is similar to the mass order process depicted in FIG. 4, in which the contents of the shipment are the same for all locations included in the push order, with the shipping address left as the only variable. The system retrieves the first shipping address in the push order (step 604) and inserts this address into a copy of the ship order template (step 605). The system then determines if there are more shipping addresses in the push order (step 606). If there are more shipping addresses in the order, the system retrieves the next one and inserts into another copy of the ship order template as described above and repeats this process until all of the individual shipping locations that constitute the push have separate shipping orders.

After the individual ship orders are created, the system determines the designated courier for the push and notifies the courier of the shipping order (step 607). The system requests a printer for printing shipping documents (step 608) and prints out the proper shipping label 609 and packing list 610 for the first individual ship order. The system then determines if there are more labels and shipping documents to be printed (step 611), and repeats the process until shipping labels and packing lists are printer for each shipping location in the push order.

After the individual shipping documents are created, warehouse personnel can pack each shipment and prepare it for delivery (step 612). As each shipment is prepared and ready to go, updates are made to various data files 613 to reflect the shipment. The inventory files are automatically decremented to indicate that those items are taken and no longer available for other orders. ICEH and SASH files are also updated to reflect the shipments.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

We claim:

1. A method for creating shipping orders, the method comprising the computer implemented steps of:
receiving an order to be sent to a plurality of specified locations, wherein all of the locations are to receive the same order contents;
retrieving, from a database, a shipping address associated with each of the plurality of specified locations;
creating a shipping order template, wherein the shipping order template specifies the contents of the order and has a blank field for designating a delivery address to which the order should be sent; and
creating a separate shipping order for each shipping address, wherein a copy of the shipping order template is created and a delivery address is filled into the blank field, wherein the separate shipping orders for the plurality of delivery addresses all have the same contents.

2. The method according to claim 1, further comprising printing shipping documents for each separate shipping order.

3. The method according to claim 2, wherein the shipping documents include a shipping label and packing list.

4. The method according to claim 1, further comprising updating inventory files to reflect a reduction of inventory due to fulfillment of the order.

5. The method according to claim 1, further comprising selecting a shipping courier and notifying the courier of the order.

6. The method according to claim 1, wherein the plurality of locations are product distributors.

7. The method according to claim 1, wherein the shipping addresses stored in the database are provided by the party submitting the order request.

8. A computer program product in a computer readable medium, for creating shipping orders, the computer program product comprising:
first instructions for receiving an order to be sent to a plurality of specified locations, wherein all of the locations are to receive the same order contents;
second instructions for retrieving, from a database, a shipping address associated with each of the plurality of specified locations;
third instructions for creating a shipping order template, wherein the shipping order template specifies the contents of the order and has a blank field for designating a delivery address to which the order should be sent; and
fourth instructions for creating a separate shipping order for each shipping address, wherein a copy of the shipping order template is created and a delivery address is filled into the blank field, wherein the separate shipping orders for the plurality of delivery addresses all have the same contents.

9. The computer program product according to claim 8, further comprising fifth instructions for printing shipping documents for each separate shipping order.

10. The computer program product according to claim 9, wherein the shipping documents include a shipping label and packing list.

11. The computer program product according to claim 8, further comprising sixth instructions for updating inventory files to reflect a reduction of inventory due to fulfillment of the order.

12. The computer program product according to claim 8, further comprising seventh instructions for selecting a shipping courier and notifying the courier of the order.

13. The computer program product according to claim 8, wherein the plurality of locations are product distributors.

14. The computer program product according to claim 8, wherein the shipping addresses stored in the database are provided by the party submitting the order request.

15. A system for creating shipping orders, the system comprising:
a means for receiving an order to be sent to a plurality of specified locations, wherein all of the locations are to receive the same order contents;
a means for retrieving, from a database, a shipping address associated with each of the plurality of specified locations;
a means for creating a shipping order template, wherein the shipping order template specifies the contents of the order and has a blank field for designating a delivery address to which the order should be sent; and
a means for creating a separate shipping order for each shipping address, wherein a copy of the shipping order template is created and a delivery address is filled into the blank field, wherein the separate shipping orders for the plurality of delivery addresses all have the same contents.

16. The system according to claim 15, further comprising a means for printing shipping documents for each separate shipping order.

17. The system according to claim 16, wherein the shipping documents include a shipping label and packing list.

18. The system according to claim 15, further comprising a means for updating inventory files to reflect a reduction of inventory due to fulfillment of the order.

19. The system according to claim 15, further comprising a means for selecting a shipping courier and notifying the courier of the order.

20. The system according to claim 15, wherein the plurality of locations are product distributors.

21. The system according to claim 15, wherein the shipping addresses stored in the database are provided by the party submitting the order request.
